(19) United States
(12) Patent Application Publication
(10) Pub. No.: US 2003/0033358 A1
(43) Pub. Date: Feb. 13, 2003

(54) Extensible client aware hierarchical file management in a wireless portal system

(76) Inventors: Luu Tran, Santa Clara, CA (US); Jeff Blattman, San Jose, CA (US); Greg Ziebold, Superior, CO (US)

Correspondence Address: WAGNER, MURABITO & HAO LLP, Third Floor, Two North Market Street, San Jose, CA, 95113, US

(21) Appl. No.: 09/929,743

(22) Filed: Aug. 13, 2001

(51) Int. Cl. G06F 15/16

(52) U.S. Cl. 709/203; 709/228

(57) ABSTRACT

A wireless portal system having a wireless server with a client aware file management system. The client aware file management system includes logic for identifying client wireless devices connecting to the wireless server by using particular characteristics of the client in granting service file access in response to connection requests from the client to the server. In one embodiment of the invention, the client aware file management system includes extensible hierarchical modular file parameters that allow the client to add-on client file information characteristics which are not already pre-stored in the wireless server. The file management system receives an indication of a client type and uses this information to automatically construct files available for the client. A hierarchical file system helps to locate the best available file. By automatically constructing the file path in an intelligent manner, more clients can be supported by the server with more customized data delivery and appearances.

### CROSS REFERENCE TO RELATED APPLICATION

This patent application is related to co-pending patent application serial No. ______, filed on ______, by Luu Tran et al., entitled “Client Aware Detection in a Wireless Portal System”, attorney docket No.: SUN-P6087, which is hereby incorporated herein by reference in its entirety.

### FIELD OF THE INVENTION

The present claimed invention relates generally to the field of wireless communication systems. More particularly, the present claimed invention relates to client aware file system management in a client independent wireless environment.

### BACKGROUND ART

The Internet has become the dominant vehicle for data communications. And with the growth of Internet usage has come a corresponding growth in the usage of Internet devices, wireless devices and services.

The growing base of Internet users has become accustomed to readily accessing Internet-based services such e-mail, calendar or content at any time from any location. These services, however, have traditionally been accessible primarily through stationary PCs. However, demand is now building for easy access to these and other communication services for mobile devices.

As the demand for mobile and wireless devices increases, enterprises must rollout new communication capabilities beyond the reach of traditional wired devices, by extending the enterprise with extra-net applications, etc., to effectively and efficiently connect mobile employees with their home base. As the number of digital subscribers grows, traditional wireless providers must find applications suitable to the needs of these new mobile users.

However, service providers are not the only ones seeking applications to meet the growing service needs of wireless users. Traditional portal developers are also extending their traditional PC browser desk-top services to these new wireless markets.

With the growth of the wireless market comes a corresponding growth in wireless business opportunities, which in today's ever-growing markets means, there is a plethora of services available to customers of the people that use these services. Many wireless service providers are now looking to add to basic core services by extending services such as e-mail, short messaging service notification, and other links to IP-based applications to drive additional business and revenues.

As the wireless market grows and Internet access becomes more mainstream and begins to move to new devices, wireless service providers are looking to develop highly leveraged Internet Protocol based applications on top of existing network infrastructure. To meet the growing demand for wireless client devices, enterprises need to provide access to any type of service from any type of device from anywhere and to provide content suitable for these devices without incurring substantial cost overhead.

The growth in wireless devices also means that traditional computer users who used to be tied to their desktop computers may now be mobile and would require remote access to network applications and services such as email. The mobility of wireless users presents a host of challenges to service providers who may have to provide traditional services to these new wireless devices. One such service is provided by Sun Microsystems, Inc., through its iPlanet™ platform to allow service providers to grow their services from basic traditional services such as voice to leading edge wireless applications with carrier-grade reliability and performance.

In addition to the traditional network applications that these new wireless users seek, the growth of the Internet and the introduction of new Internet enabled wireless devices have led to the explosive use of community-based web sites or portals. The growth in portals has created a need for wireless environments to provide portal support to handle the collection of data related to different topics such as news, stock quotes, applications and services required by wireless device users.

FIG. 1 depicts a prior art wireless client dependent based environment solution to handle similarly configured wireless clients running similar applications or portals. The environment depicted in FIG. 1 includes wireless devices such as a WAP phone 101, a wireless PC 102, a refrigerator 103, etc. In general, the wireless environment depicted in FIG. 1 is categorized into the network (Internet 104), Clients (e.g. mobile phone 101, PCs 102 and household appliances 103) and resources (e.g., web-sites 105, portals 106 and other applications 107).

For most of the wireless clients connected to the Internet 104, portals 106 offer the client the starting point of experiencing the Internet 104. Portals 106 are typically community-based web-sites that securely hold a collection of data related to different topics, including such applications as news, stock quotes, etc. For example, a wireless client connecting to the Internet will first login to a web portal site (e.g., yahoo) and from there browse through various sites to search for a host of different services.

The portals typically reside in a portal server which bundles an aggregation of services provided by an Internet service provider and provides these services to wireless clients. A wireless portal server such as that developed by Sun Microsystems, Inc. provides such portal access to wireless application resources residing on resource servers A 108, B 109 and C 110.

The prior art wireless server depicted in FIG. 1 primarily supports the two major types of browsers known by most Internet users. These include the Microsoft Internet Browser and the Netscape Communicator Browser. These browsers are both Hyper-Text Markup Language (HTML) based and suitable for some wireless devices, especially devices with large display screens. However, as wireless display screens get smaller in size, traditional HTML browsers are no longer suitable for transmitting content to these wireless devices.

To ensure suitable content delivery, wireless device and wireless software providers have developed a myriad of micro-browsers which appropriately adapt to these wireless devices with different display screen requirements in order to take advantage of the numerous content on the Internet. The availability of these new micro-browsers means that service providers do not have to create different sets of content for different wireless devices even if the devices are dissimilar.

In the prior art systems such as that shown in FIG. 1, the server is configured to store files needed by clients in a disk management structure that only avails specific files to devices generically configured. This file system setup leaves little room for device customization and client awareness.

File system management in the prior art system depicted in FIG. 1 is performed on a per-platform basis and on predefined device dependent characteristics with predetermined and static file paths. This means that similarly configured devices can only access the file server via device specific drivers. The use of device drivers requires the system administrator to constantly load new software on the server every-time new devices are granted access rights to files on the server.

The system administrator may also have to reboot the file server each time a device driver is added to the file system in order to allow the file server to recognize the new drivers. This can be very cumbersome and lead to system down time. The use of device drivers also inhibits the ability of end-users to perform file system management functions, especially if the end-user is not a sophisticated software programmer.

Another drawback of the prior art system such as that depicted in FIG. 1 is the use of predefined files which a class of wireless clients may access. Predefining files to grant access to wireless clients restricts the ability and flexibility of the wireless server to dynamically add new clients during client run-time and server up-time. Also, if files are predefined for a particular client, it is difficult to adapt the file to suit another client within the same class of devices, but with different file requirement characteristics.

Thus, for the prior art server to support the variety of wireless clients that service providers support, the system administrator will have to painstakingly add client specific files to support each wireless client if and when the client attempts to access the server.

The file systems of the server type shown in FIG. 1 also have the limitation of restricting a file path, typically, to 4 parameters (e.g., domain, location, component, filename). This limits the amount of detailed client information that could be stored about a client in the wireless environment.

As the number of models of wireless clients increase, the prior system of having restricted file paths and very limited information about client characteristics impairs the ability of service providers to take advantage of new wireless technologies and provide efficient and cost effective services. This also impairs the ability of the wireless client to enjoy the full richness and look and feel of user interfaces provided by the server.

### SUMMARY OF INVENTION

Accordingly, to take advantage of the myriad of wireless applications and the numerous wireless clients being developed, a wireless server with extensibility capabilities to allow wireless clients to be dynamically configured and detailed client specific files by the wireless server is needed. A need exists for “out-of-the-box” wireless client aware system solutions to allow technically unsophisticated end-users to connect to the wireless environment without unduly tasking the end-user's technical abilities. A need further exists for an improved and less costly device independent system that improves efficiency and provides access to various wireless clients of different configurations without losing the embedded features designed for these devices.

Embodiments of the present invention are directed to a system and a method for a wireless client aware hierarchical file management system in a wireless network environment. In general, embodiments of the present invention vary the degrees of accessing file systems for a wireless client connecting to the wireless environment by implementing a hierarchical search of a file system structure to retrieve files with detailed client information. In one embodiment, the invention provides client specific hierarchical file system access in a wireless network environment. The invention is suitably adapted to function in a wireless portal environment.

Embodiments of the invention include an extensible pluggable file system manager to dynamically allow client aware file system additions to existing file system structure. The pluggable file system manager provides the wireless service provider the flexibility to be able to extend the file access characteristics of the wireless client based on client specific characteristics and attributes. Consequently, the file manager scheme of the present invention uses client specific information to a class of wireless devices to provide custom access parameters for clients.

In one embodiment of the present invention the file system manager is able to retrieve files in a client aware manner to allow clients of the same or similar configuration or class to access files unique to a particular client's capabilities. Client awareness means the present invention is able to provide files requested by a particular client based on characteristics unique to the particular client.

Embodiments of the present invention further include client extensible logic which allows the file system manager to automatically add run-time client characteristics to any default client information that may exist in the file system in order to enable the client to enjoy the interfaces the server provides. In this way, the file manager logic of the invention is extensible to configure new device characteristics without requiring specific device drivers or software updates. An Application Programmable Interface can be used to collect extensible data sets that include custom parameters for automatically identifying non predefined file characteristics of a particular client or class of clients.

In one embodiment, automatic client detection logic identifies the type or class of the client and stores this information into a client session data structure. The client session information can then be used by consumers of the hierarchical file system to automatically access the most pertinent configuration data for the client using an intelligent file look-up system. Client identification or class information can be used in automatically constructing a path to the most pertinent configuration data for the client. The file management system receives an indication of a client type and uses this information to automatically construct files available for the client. A hierarchical file system helps to locate the most specific available file for the client. By automatically constructing the file path in an intelligent manner, more clients can be supported by the server with more customized data delivery and appearances.

These and other objects and advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrates embodiments of the invention and, together with the description, serve to explain the principles of the invention:

Prior Art FIG. 1 is a block diagram of a conventional device dependent wireless system;

FIG. 2 is a block diagram of an implementation of a device independent wireless system of the present invention;

FIG. 3 is a block diagram of an exemplary internal architecture of the wireless server of FIG. 2;

FIG. 4 is a block diagram of an embodiment of an internal architecture of a file manager module of the present invention; and

FIG. 5 is an exemplary depiction of one embodiment of a file system path of a file manager module of the present invention.

### DESCRIPTION OF THE PREFERRED EMBODIMENTS

Reference will now be made in detail to the preferred embodiments of the invention, examples of which are illustrated in the accompanying drawings. While the invention will be described in conjunction with the preferred embodiments, it will be understood that they are not intended to limit the invention to these embodiments.

On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well known methods, procedures, components, and circuits have not been described in detail as not to unnecessarily obscure aspects of the present invention.

The invention is directed to a system, an architecture, subsystem and method to manage files in a client independent wireless environment in a way superior to the prior art. In accordance with an aspect of the invention, a wireless server provides wireless client aware file system management, which enables client characteristics of non, predefined devices to be used in accessing files stored in the wireless server.

In the following detailed description of the present invention, a hierarchical file management system in a system and method for a wireless Internet protocol based communication system is described. Numerous specific details are not set forth in order to provide a thorough understanding of the present invention. However, it will be recognized by one skilled in the art that the present invention may be practiced without these specific details or with equivalents thereof.

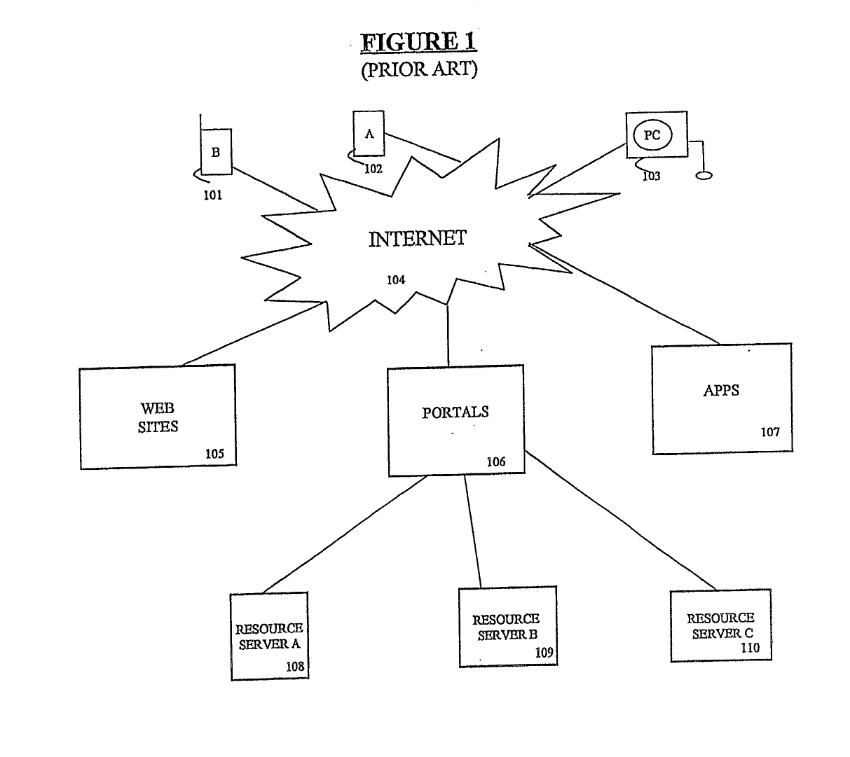

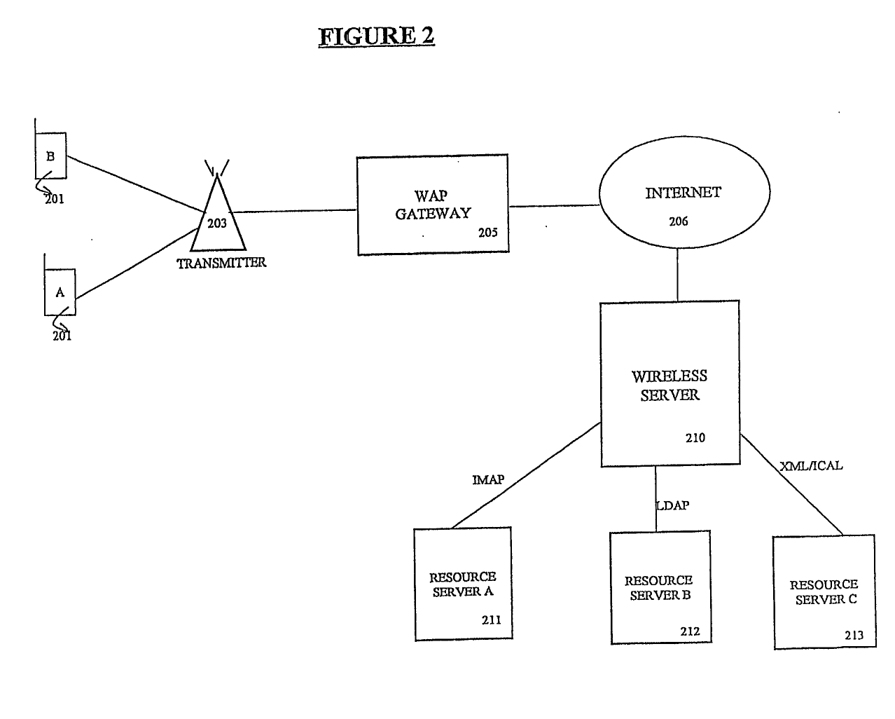

Generally, an aspect of the invention encompasses providing an integrated wireless Internet server which provides a wide range of voice, data, video and other services to wireless clients which may connect to the wireless environment to be serviced alongside predefined wireless clients. The invention can be more fully described with reference to FIGS. 2 through 4.

FIG. 2 depicts a wireless device independent based environment of the present invention. The wireless environment depicted in FIG. 2 comprises a wireless application protocol (WAP) based phone 201, a WAP transmission infrastructure 203, a WAP gateway 205, the Internet 206 and a wireless server 210. The WAP gateway 205 typically resides on the Local area network (LAN) within telecom carrier premises. It is generally not a part of the wireless server 210. The WAP gateway 205 is responsible for converting the Wireless Markup Language (WML)/Hyper Text Transport Protocol (HTTP) content and protocol into a binary compressed, encoded, encrypted version of WML over WAP.

Conversely, the WAP gateway 205 also performs the translation of WAP commands into HTTP requests that can be sent over the public Internet 206. For example, in a GSM network, when a phone transmission is received by the mobile switching center, it realizes it is a packet data and sends it to the proper channel to be processed. The WAP gateway 205 decompresses and decrypts the packets, as well as several other functions and formats the data into an HTTP request that is sent to the wireless server 210. The WAP gateway 205 can also store user's bookmarks, two of which could point to the wireless server's messaging and other resource services. The wireless server 210 communicates Wireless Markup Language (WML) over HTTP on the front-end and communicates in native protocol of the target server on the back-end.

The wireless server communicates to these back-end resource servers using the backend server's native protocol. For example, the wireless server may communicate to resource server A 211 which may be a messaging server using IMAP. Lightweight Directory Access Protocol (LDAP) is used for all communications to and from the resource server B 212. And a Extensible Markup Language (XML) protocol may be used to communicate with resource server C 213.

Although the wireless server depicted in FIG. 2 is capable of communicating in these native protocols shown in FIG. 2, the wireless server's 210 protocol handling capability can be extended to support a variety of other protocols. The wireless server implements the WML interface and generates the corresponding WML content based on what it receives from the back-end server. The wireless server 210 also processes incoming HTTP requests in which a wireless device sending data or a request to the back-end servers. The wireless environment depicted in FIG. 2 typically supports wireless devices of dissimilar configuration and is thus device independent.

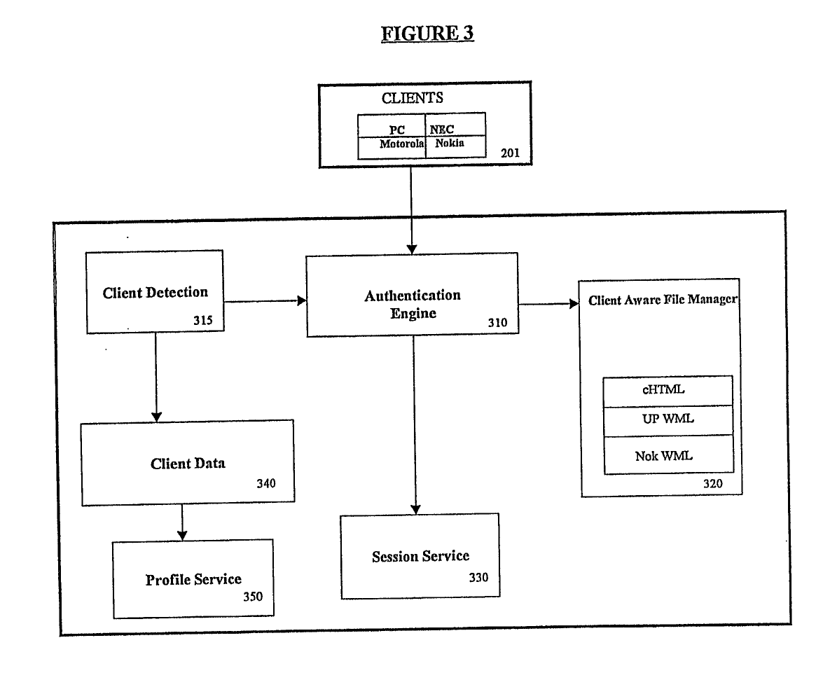

FIG. 3 is a block diagram illustration of one embodiment of the wireless server of the present invention. Wireless Server 210 (WS) comprises, Authentication module 310, Client Detection module 315, File Manager 320, Profile Service (PS) module 350, Session Service (SS) module 330 and Client Data module 340. WS 210 may include other modules that have not been disclosed here in order not to confuse the teachings of the present invention.

The wireless server depicted in FIG. 3 is a flexible, scalable, extensible and capable of supporting a rich evolving range of networks such as Global System for Mobile communication (GSM) Networks, Code Division Multiple Access (CDMA) Networks, Time Division Multiple Access (TDMA) Networks, Third Generation (3G) Networks and others.

The architecture of the server is also capable of handling a variety of wireless environments and markup languages such as the wireless markup language (WML), the handheld device markup language (HDML) and the hypertext markup language (HTML). The server is capable of providing support for multiple devices and is easily adaptable and extensible to additional devices and markup languages.

Still referring to FIG. 3, FM 320 is coupled to the Authentication service engine 310 to handle file access requests presented by wireless clients authorized to connect to the wireless server 210 via a client file software lookup API. FM 320 stores file template modules which enable the server 210 to map client file requests that are used to uniquely identify and retrieve files from the file system in a client aware manner. As used throughout this application, a client refers to independent wireless devices that may connect to the wireless server 210. In accordance with embodiments of the present invention, FM 320 performs specific hierarchical file retrieval as defined with client specific parameters. These parameters may include the client's display capabilities, memory capacity, bandwidth capabilities, etc.

In a preferred embodiment of the present invention, FM 320 uses client type information received from Client Detection module 315 in retrieving client specific files from file systems in server 210 in response to client specific requests. Consequently, FM 320 is not directly tied to any particular markup language or protocol. The Function of Client Detection Module 315 is described in the copending US patent application entitled “CLIENT AWARE DETECTION IN A WIRELESS PORTAL SYSTEM”, filed ______, assigned to the assignee of the present invention and hereby incorporated herein by reference.

FM 320 is also extensible to enable client specific characteristics to be dynamically added automatically to the file system structure of the wireless server 210 while the client communicates with the server 210 to ensure client aware file retrieval in the wireless environment. FM 320 includes logic that instructs file-processing modules in the wireless server 210 where to look in the file system structure to retrieve client specific files without specifically providing the server with specific information as to the file name. In other words, the logic is such that the most pertinent file is located for a client based on the hierarchical structure and the wireless server 210 is able to hierarchically retrieve client specific files without having to traverse the entire file path of the file system structure for a particular file.

Because FM 320 consists of a set of classes and methods that understand the user interface of the client, it is a fairly straightforward process to extend FM 320 to include additional clients. For example, if the developer wished to support a new phone that had a wide screen, the developer could create a new template class or a subclass of the existing WML class with newly implemented methods or over-ridden methods of the parent class. The new class would then understand that the client has a wider screen and would deliver the WML content to the phone in longer strings.

The file path information is accessed by a client type key stored in the session service module 330 as part of the data associated with the client type information provided by Client Detection module 315. The file path identifies where hierarchically in the file system structure to look for client specific files in the client's service request.

In the present invention, file requests are mapped to client type parameters in order to retrieve client specific files in response to file access request from the client. One way to have a system behave differently or depending on the accessing device enabling the system to become client aware is through the retrieval of client specific files. The files can be configuration files, templates, XSL sheets or any number of types of data.

By using FM 320 to retrieve files, the present invention ensures client awareness in the wireless environment. In other words, Wireless server 210 is able to request client specific files without having to transmit the entire file path information of the file being sought.

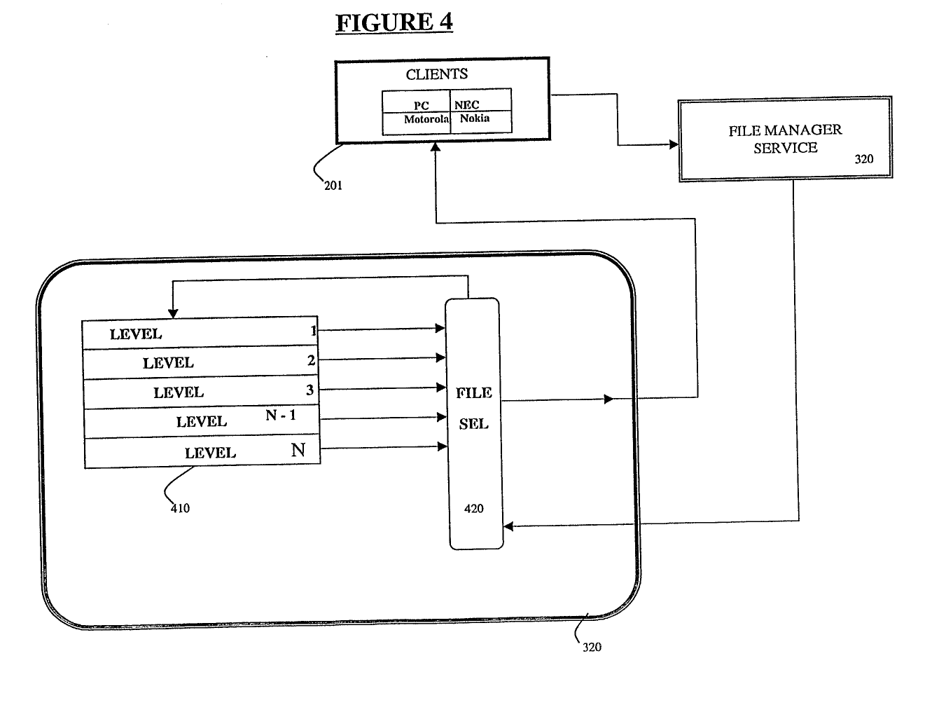

FIG. 4 is a block diagram illustration of one embodiment of the File Manager Modules of the File Manager system 320 of the present invention. The File Manager Module 320 includes independently pluggable modules 410 representing various files or directories and file selector 420.

As depicted in FIG. 4, files representing various levels of client specific information are stored in the wireless server 210 disk storage units and selectively identified by FMM 410 in response to client file requests. In one embodiment of the present invention, level 1 through level N represent the hierarchical file path of client aware files which may represent a class of clients or a sub-class of clients in the wireless network.

Files stored in levels 1 through N−1 contain inherent client capability information, which have been categorized by client type detection system 315 of the wireless server 210. FMM 410 is hierarchical and allows granular file access to detailed and generic file characteristics of clients in order to control the behavior of different clients while avoiding the difficulty that comes with configuring this detailed level of client information configuration.

For example, if the service provider wanted to configure files for a WAP Nokia phone with a model number 7110 that happens to be a German client, the hierarchical structure of FMM 410 will include at the top level (e.g., level 1) generic information for WAP phones, the second level will include generic files for Nokia phones, a third level will include generic client information for Nokia Model 7110 phones, and a fourth level will include regional specific information for WAP Nokia German Model 7110 phones. Knowing the client identification from the client session 330, the FM 320 is able to traverse through the hierarchical file structure to locate the most custom file available, e.g., the most pertinent file for the client.

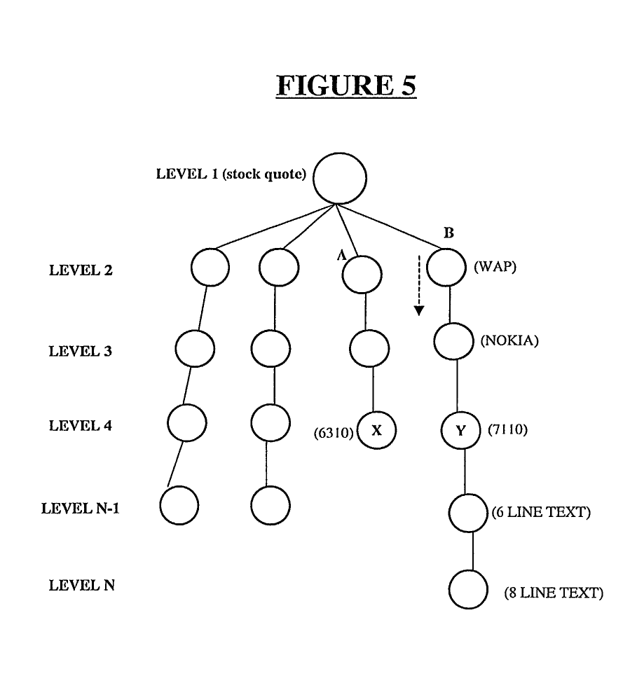

At a finer granular level, client specific characteristics or capabilities can be dynamically added automatically during client run-time or via a system administrator's update to the file hierarchy structure. An example of this, as depicted in FIG. 5, will be a German Nokia WAP phone Model 7110 with an 8 line text display capabilities and a similar phone with a six text line display capabilities. Either phone may dynamically store detailed file requirements (e.g., 8 lines of text v. 6 lines of text display capability) during client run-time. Once this level of detail is stored, depending on the server the client is accessing, this level of detailed information may be permanently stored in client data module 340 or temporary in session service 330 until the client's session is terminated. Having such a hierarchical structure of client files enables the client to experience the full richness of its interface with the wireless server by tailoring its behavior based on the available files in the system.

Furthermore, by having a hierarchical structure, FMM 410 is able to provide a backward compatibility platform for clients within a class or sub-class e.g., WAP German Nokia phones model 7110 with either six or eight display text capabilities will still be able to access the wireless server if the finer granularity of detail files (e.g., display text capabilities) is not available in the file system. The client will still be able to use the file path from the generic WAP information to the German model 7110 file to access the wireless server.

Referring still to FIG. 4, file selection by FM 320 is performed by File selector 420 which is used to retrieve either generic or client specific files from FMM 410. File selector 420 selects the appropriate files based on the header information included in the client service requests. The header information may include HTTP headers, user programmable headers, client equipment manufacturer specific headers, etc. FMM 410 is extensible to enable dynamic addition of client run-time files to existing files in the server's file system structure. Having an extensible file system enables the wireless service provider to add or delete unique client file identifying characteristics “on-the-fly” on top of predefined files stored in the server in order to offer access to categorized classes of clients or a client.

Having an extensible modular file manager scheme also means that wireless service providers can perform simple code additions to the file manager service. This is more efficient and cost effective than the more expensive way of entirely upgrading the wireless server each time the service provider changes the predefined client file parameters of the services they provide.

FIG. 5 is an exemplary illustration of a file path of one embodiment of the file retrieval process of the present invention for clients in the same class, but with different file requirements. In the example depicted in FIG. 5, when FM 320 receives a file request, for example a stock quote, to the wireless server from two Nokia phones of the same model configuration, but with different display characteristics (e.g., six text v. eight text), client type information embedded in the request headers of each request is used to determine the best path to follow to retrieve the requested stock quote file named “stockfile”. In this example, the user of each phone would enter the same file name “stockfile”, but based on the client type information provided by the client detection module, the Model 7110 phone will have a model 7110 tag as the equipment type in the request header and the Model 6310 phone will have an Model 6310 tag as the client type in the header request. FM 320 then uses the client type information, in this case Model 7110 and Model 6310, to traverse paths A and B respectively to retrieve a stock quote file Y that is suitable for display on the model 7110 phone and File X is retrieved for display on the Model 6310 phone. Thus in each case, the client phone does not have to specify to the file manger the file path to retrieve either File X or File Y.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications are suited to the particular use contemplated. It is intended that the scope of the invention be defined by the claims appended hereto and their equivalents.

1. A wireless server system comprising:
a plurality of extensible hierarchical file modules, each providing respective identifying file parameters pertinent to a type of wireless client; and
a file manager service, in response to receiving a particular client type associated with a particular wireless client for dynamically selecting files in said plurality of hierarchical file modules based on said particular client type,
wherein said file manager service is also for applying a selected file module to said particular wireless client for identification thereof.

2. The wireless server system of claim 1, further comprising an automatic client aware detection service for automatically detecting client specific files in response to service requests that originate from said particular wireless client.

3. The wireless server system of claim 2, wherein information found with the client service request comprises file information unique to a particular class of clients or said particular client.

4. The wireless server system of claim 1, wherein said plurality of file modules are arranged to form a hierarchical file path with client data generic to a particular class of client information at the top-most level of the hierarchy.

5. The wireless server system of claim 4, wherein said hierarchical file path has, at its lowest level, client file information unique to a particular client to differentiate said particular client from others within said class of clients.

6. The wireless server system of claim 5, wherein said file manager traverses said hierarchical file path to retrieve client aware specific files in response to client file request without said client having to provide the entire file path of the file to be retrieved.

7. A client aware hierarchical file manager system in a wireless network, comprising:
a wireless server;
a plurality of a classes of wireless clients, each having unique file parameters; and
an extensible file manager service for providing a file storage and
retrieval procedure in response to file accesses requests from said wireless clients.

8. The client aware file manager system of claim 7, wherein said file manager service comprises a plurality of extensible hierarchical file modules having dynamic file addition attributes to dynamically add client specific files to existing file system structure in said wireless sever during said client's run-time.

9. The client aware file manager system of claim 8, wherein the file manager service further comprises a file selector for selectively traversing said extensible hierarchical file modules to retrieve files based on client type information of a client accessing the wireless server.

10. The client aware file management system of claim 9, wherein said file manager service receives and parses service requests from the wireless clients to determine the file path to the file being requested by the wireless clients.

11. The client aware file management system of claim 10, wherein the plurality of extensible hierarchical file modules include a set of predefined file parameters generic to clients within a class of wireless clients used by the wireless server to identify said clients with known file characteristics accessing the wireless server.

12. The client aware file management system of claim 9, wherein the wireless file server includes a file system structure capable of being dynamically updated with client file information during said client's run-time.

13. A wireless server, comprising:
a client aware file manager service for providing file storage and retrieval service to a plurality of wireless clients accessing the wireless server; and
a plurality of client aware hierarchical file modules for hierarchically storing file characteristics pertinent to a particular client and a class of clients within said plurality of wireless clients;
a client data storage for storing client type information; and
a session service logic for storing transient session information for said clients accessing said wireless server.

14. The wireless server of claim 13, wherein said plurality hierarchical file modules are extensible to allow dynamic file addition of client attributes to existing file system structure in said wireless sever during said client's run-time.

15. The wireless server of claim 13, wherein the file manager service further comprises a file selector for selectively traversing said hierarchical file modules to retrieve files based on client type information of a client accessing the wireless server.

16. The wireless server of claim 15, wherein said file manager service receives and parses service requests from the wireless clients to determine the file path to the file being requested by the wireless clients.

17. The wireless server of claim 16, wherein the plurality of hierarchical file modules comprise a set of predefined file parameters generic to clients within a class of wireless clients used by the wireless server to identify said clients with known file characteristics accessing the wireless server.

18. The wireless server of claim 16, wherein the file manager module comprise file selection logic to selectively retrieve files from file system structure in the wireless server in response to a client service request.

19. The wireless server of claim 16, wherein said client service request includes hyper text transport protocol request headers.

20. The wireless server of claim 16, wherein said client service request includes client equipment manufacturer specific headers.

21. The wireless server of claim 20, wherein the client service request includes programmable user specified headers.

22. A client aware file management service, comprising
a plurality of client aware file characteristics modules; and client aware file selection logic.

23. The client aware file management service of claim 22, wherein said plurality of client aware file characteristics modules comprise a predefined set of client files for defining known clients accessing the client aware file management modules.

24. The client aware authentication module of claim 22, wherein said plurality of client aware file characteristics modules comprise client characteristics dynamically extracted from the clients run-time environment.
